(19) United States
(12) Patent Application Publication
(10) Pub. No.: US 2002/0090563 A1
(43) Pub. Date: Jul. 11, 2002

(54) Digital image recording process, toner for a color printer or copier device, and a color printer or copier device

(76) Inventors: Domingo Rohde, Kiel (DE); Detlef Schulze-Hagenest, Molfsee (DE); Dinesh Tyagi, Fairport, NY (US)

Correspondence Address: Lawrence P. Kessler, NexPress Solutions LLC, Patent Department, 1447 St. Paul Street, Rochester, NY, 14653-7103, US

(21) Appl. No.: 10/022,479

(22) Filed: Dec. 17, 2001

(30) Foreign Application Priority Data
Dec. 22, 2000 (DE) 100 64 562.3
Jul. 24, 2001 (DE) 101 35 865.2

(51) Int. Cl. G03G 9/09

(52) U.S. Cl. 430/107.1; 430/124; 430/105

(57) ABSTRACT

A digital image recording process is proposed. The process provides that a color toner image made of toner layers having different colors is transferred onto an image receiving substrate and then fused and fixed onto the image receiving substrate by impingement with electromagnetic radiation. The process is characterized in that in order to produce the color black, at least one toner layer is used that has similar absorption properties, at least for one wavelength within a predetermined wavelength range for the electromagnetic radiation, as the other toner layers that are used.

### FIELD OF THE INVENTION

The invention involves a digital image recording process in which a color toner image made from toner layers that have different colors is transferred onto an image receiving substrate and then fused and fixed to the image receiving substrate by impingement with electromagnetic radiation, a device for performing the process, a toner for a color printer and/or copier device.

### BACKGROUND OF THE INVENTION

A known digital image recording process is electrostatic printing, in which a latent electrostatic image is developed by charged toner particles. These particles are transferred onto an image receiving substrate, hereinafter referred to simply as “substrate”. Afterwards, the developed image that has been transferred onto the substrate is fixed by the toner particles being fused by supplying them with heat.

To fuse the toner particles, contacting processes are often used in which the toner particles are brought into contact with suitable devices, for example, hot rollers or cylinders. It is disadvantageous in this process that the design, the maintenance and the operating costs of these heating devices that operate by contact are expensive and thus cost intensive. Furthermore, it is necessary to use silicone oil as a separating agent that should prevent an adhesion of the fused toner onto the heating device. In addition, the defect rate caused by the contacting heating devices is relatively high.

In order to fix the toner that is transferred onto the paper, for example, heating devices and processes are also known that operate in a contactless manner, in which for example, the toner particles are fused using heat radiation and/or microwave radiation or with hot air, so that they adhere to the paper.

In relation to non-contacting fixing devices, it is already known to use electromagnetic radiation with wavelengths of between 0.8 μm and 10 μm, i.e. electromagnetic IR radiation, to fuse toner layers. Possible embodiment forms include the fusing and fixing in one step, the melting of UV toner prior to curing or the preheating of paper, on which toner has been applied, prior to the fusing of toner layers by other technologies. For single color printing, especially black printing, IR radiation with short and medium wavelengths has already been used for a long time. According to the state of the art, only IR radiation with long wavelengths is used for color toner, whereby the image carrier substrate, such as paper, and the color toner absorb almost 100% of the IR radiation. For example, the absorption properties of toners for the three process colors cyan, magenta, and yellow differ, however, considerably from the absorption properties of black toners, especially for electromagnetic radiation with wavelengths below 7 μm. Paper as an image receiving substrate typically absorbs less than 5% of visible electromagnetic radiation, more than 60% for electromagnetic radiation at wavelengths above 2 μm and practically the entire IR radiation at wavelengths of greater than 10 μm. The process color pigments absorb visible electromagnetic radiation within limited wavelength ranges, while they typically absorb less than 10% of IR radiation at wavelengths below 5 μm. Known black toners absorb almost 100% of electromagnetic radiation at wavelengths in the range of between 0.8 μm and 10 μm or less.

These different absorption properties cause a non-uniform fusing behavior during the fusing of toner layers by IR radiation having short and medium wavelengths. This non uniform fusing behavior appears, for example, in the form of non uniform fixed toner, non uniform gloss properties, by an undesired bubble formation or by a localized overheating of the image receiving substrate, resulting in color changes.

Because of the known unequal absorption properties of black toners and color toners, the fusing of the corresponding toner layers according to the state of the art is performed only with IR radiation, which has wavelengths of greater than approximately 7 μm, since for these types of wavelengths, both the toner and the paper absorb practically the entire radiation. However, the intensity of the IR radiation is relatively low with wavelengths of greater than 7 μm. As a result of this, the problem occurs that in order to fuse the toner layers, relatively long time intervals are required which make it necessary to reduce the throughput speeds of the image receiving substrate through the corresponding printing or copying devices, or to provide fusing areas in the devices that have large surfaces.

To solve this problem, it has already been proposed to add additives to the process color toners in order to adapt the absorption properties of the process color toners to the absorption properties of the black toners, especially for the wavelength range between 0.7 μm and 2 μm. Additives or absorbers of this type are, however, very expensive. Furthermore, absorbers and/or additives of this type in the visual range of electromagnetic radiation are not completely colorless, which can have negative effects on the color reproduction.

### SUMMARY OF THE INVENTION

Thus, the purpose of the invention is to provide a process, a toner, and a device with which it is possible to preheat, fuse, or melt, by electromagnetic IR radiation, a color toner image made of toner layers having different colors on an image receiving substrate, without the previously mentioned disadvantages occurring. Another purpose consists in that IR radiation with a relatively high intensity can be used, so that for the image receiving substrate, fast throughput times can be achieved without large areas having to be irradiated with the IR radiation.

In order to achieve this purpose, a digital image recording process is proposed that provides a color toner image made of toner layers having different colors is transferred onto an image receiving substrate and then fused and fixed onto the image receiving substrate by impingement with electromagnetic radiation. The color toner image consists of at least two out of four differently colored toner layers. The image receiving substrate can, for example, be formed from a sheet or a continuous web, made of paper or cardboard. The process is characterized in that in order to produce the color black at least one toner layer is used that has similar absorption properties, at least for one wavelength within a predetermined wavelength range for the electromagnetic radiation, as the other toner layers that are used. The process makes it possible in an advantageous way to manufacture high quality color prints and color copies, in which the toner layers are fixed simultaneously and a uniform gloss is achieved, while a bubble formation is prevented. Furthermore, an overheating of the image receiving substrate, especially paper, is prevented, which in the state of the art, at least in a few cases, had been brought about by the black toner layer having been fused at a noticeably earlier time than the colored toner layers, which often led to overheating of the image receiving substrate in the area of the black toner layer.

The predetermined wavelength range for the electromagnetic radiation is generally between 0.8 μm and 10 μm.

A preferred embodiment form of the process according to the invention provides that the predetermined wavelength range is selected in a manner such that the energy of the electromagnetic radiation is predominately absorbed by the image receiving substrate and not by the toner layers. In this case, the image receiving substrate, for example, paper, is heated via the absorbed radiation and causes the toner layers to melt, so that uniform results are obtained for all toner layers.

Especially for this purpose, a preferred embodiment form of the process according to the invention provides that the predetermined wavelength range for the electromagnetic radiation is the range from 0.8 μm to 3 μm. For electromagnetic radiation with wavelengths in this range, the toner layers used according to the invention only absorb relatively little radiation, whereas the image receiving substrate absorbs a high portion of this radiation, which leads to a rapid heating up of the image receiving substrate.

In order to match the absorption properties, the process according to the invention provides that the color black is produced by a combination of different colored toner layers, for example, by a combination of the toner layers for the colors cyan, magenta, and yellow.

Furthermore, the process according to the invention can provide that the color black is formed or formed together with at least one toner layer that contains a combination of different colored color pigment particles. These different colored color pigment particles can, for example, be formed by color pigment particles that are usually used for the colors cyan, magenta, and yellow.

Preferably, the process according to the invention provides that the color black is formed or formed together with at least one toner layer that is not pigmented with carbon black. Pigmenting with carbon black is frequently used in the state of the art and leads to the absorption properties mentioned in the beginning, which differ in a disadvantageous manner from the absorption properties of different colored toner layers.

In some cases, however, it can be advantageous if the process according to the invention provides that the color black is formed or formed together with at least one toner layer that has a carbon black portion of less than 2%, preferably noticeably less than 2%. As a function of specially used carbon black, low carbon black concentrations of this type still do not act in an especially disadvantageous manner on the absorption properties, but they can produce advantages in regard to the color saturation.

Furthermore, according to the process according to the invention it can be provided that the color black is formed or formed together with at least one toner layer that contains black pigment. In order to obtain absorption properties that are as similar as possible, this black pigment should have similar properties to the pigments that are used for the other colors.

In this context, the process according to the invention can provide, furthermore, that the color black is formed or formed together with at least one toner layer that contains neutral gray pigments free of carbon black which do not act disadvantageously on the absorption properties in the sense of the invention.

It is pointed out that all of the wavelength ranges for electromagnetic radiation given are to be understood in such a way that, to be precise, the predominate portion of the electromagnetic radiation is within the respective wavelength range, but it is not ruled out by this that portions of electromagnetic radiation are also present that are outside of the respective wavelength range. This can in practice be caused, for example, in that it is often not possible to maintain the respective wavelength range precisely with real radiation sources. Furthermore, structural component tolerances, in particular, age and/or temperature dependent structural component tolerances, can also lead to portions of the electromagnetic radiation being outside of the respective wavelength range.

In order to achieve the purpose named at the beginning, a toner is proposed furthermore for a color printer and/or copier device. The toner is suitable to produce the color black and provided for the purpose of being fused by electromagnetic radiation and fixed onto an image carrier substrate. The toner according to the invention is characterized in that it has similar absorption properties, during irradiation by electromagnetic radiation with at least one wavelength out of a predetermined wavelength range, as other customary toners that are provided to produce colors other than black. Also, the toner according to the invention makes it possible, especially if it is used in connection with the process according to the invention, to make high quality color prints and color copies, in which the toner layers are fixed uniformly and a uniform gloss is achieved, while a bubble formation can be prevented.

The toner according to the invention is generally created in such a way that it can be fused with electromagnetic radiation, the wavelengths of which are in the wavelength range from 0.8 μm to 10 μm. The absorption and/or melting behavior of the toner corresponds in the process, for example, to the properties of known toners, which, for example, are used to produce toner layers of the colors cyan, magenta, or yellow.

In an especially preferred embodiment form of the toner according to the invention, the wavelength range just named above is restricted to a range of 0.8 μm to 3 μm, since electromagnetic radiation makes possible a high intensity in this wavelength range.

In this context, it can be furthermore provided that the toner according to the invention absorbs less than 10% of the energy when it is irradiated with electromagnetic radiation with a wavelength in the IR range below approximately 5 μm. A toner of this type can be used in an especially advantageous way in combination with known colored toners.

In order to achieve the purpose named at the beginning, the invention provides, in addition, a color printer and/or copier device, which transfers a colored toner image made of toner layers that have different colors onto an image receiving substrate and then fuses and fixes them by impingement with electromagnetic radiation onto the image receiving substrate. The color printer and/or copier device according to the invention is characterized in that it is provided especially for use with the toner according to the invention.

In this context, it is generally provided that the color printer and/or copier device has a radiation source to produce electromagnetic radiation at a wavelength of 0.8 μm to 10 μm.

In a similar way as in the process according to the invention, it is provided in this context, however, that the color printer and/or copier device has a radiation source to produce electromagnetic radiation at a wavelength in the range from 0.8 μm to 3 μm. The advantages that are produced especially in this wavelength range have already been explained in detail in relation to the process according to the invention. As a result, reference is made to the corresponding embodiments.

### BRIEF DESCRIPTION OF THE DRAWING

The invention is explained in greater detail using the only Figure, which shows the absorption behavior of the toner and paper.

### DETAILED DESCRIPTION OF THE INVENTION

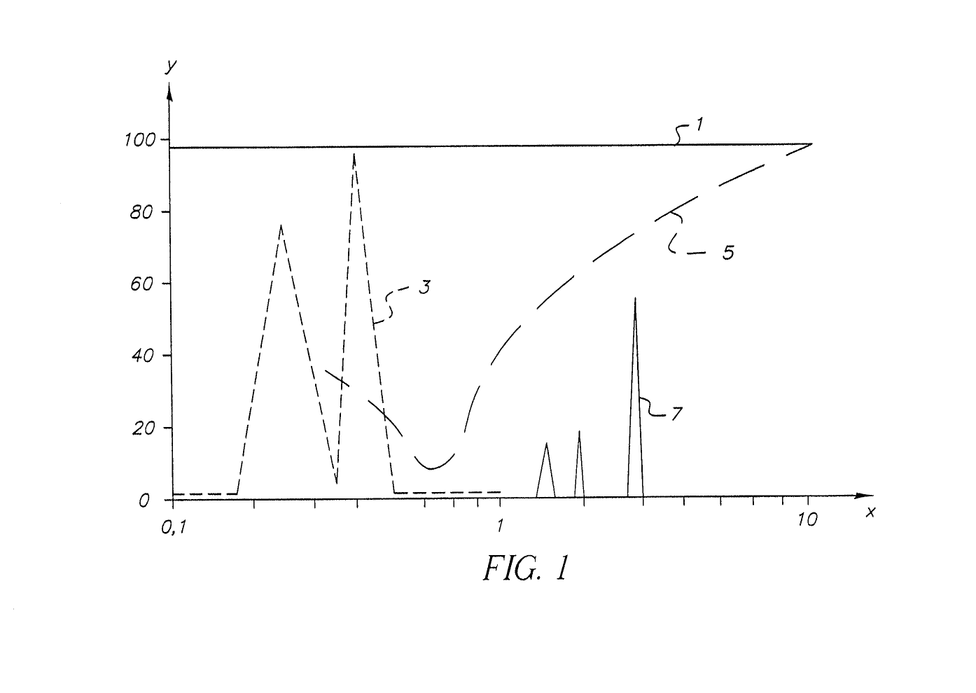

In the graph according to FIG. 1, the wavelength of the electromagnetic radiation is plotted on the x-axis in micrometers (μm), while the absorption in percent is plotted on the y-axis. The curve progression for black toner according to the state of the art is indicated by 1, while the curve progression for red toner is indicated by 3. The curve, which shows the absorption behavior of paper, is indicated by 5 and the absorption behavior of water is given for comparison by a curve that is indicated by 7. As can be ascertained from the graph of FIG. 1, black toner according to the state of the art almost completely absorbs the electromagnetic radiation over the entire wavelength range shown. In contrast to this, the red toner absorbs the radiation practically only if it has wavelengths of less than 0.7 μm. This different absorption behavior leads, in the state of the art, to the problems mentioned in the beginning. The toner according to the invention has an absorption behavior that can essentially correspond to the red toner. Thus, in the range between 0.8 μm and 10 μm, practically only paper, as the image receiving substrate, absorbs the electromagnetic radiation so that all toner layers are fused at approximately the same time, which makes possible the advantages of the invention. As mentioned, the wavelength according to the invention is preferably selected within a range of 0.8 μm to 3 μm, since the electromagnetic radiation with a wavelength of this type can have a high intensity so that for fusing, only relative short time intervals are necessary, which makes possible high throughput speeds.

The embodiment examples are not to be understood as a restriction of the invention. Moreover, numerous alterations and modifications are possible in the context of the disclosure presented, in particular such variations, elements and combinations and/or materials, which, for example, by the combination or modification of individual characteristics and/or elements or process steps, described in connection with the general description and embodiment forms as well as claims, and contained in the drawings, can be ascertained by the expert in regard to the achieving the purpose and lead, through combinable characteristics, to a new object or to new process steps and/or process step sequences.

The invention has been described in detail with particular reference to certain preferred embodiments thereof, but it will be understood that variations and modifications can be effected within the spirit and scope of the invention.

### PART LIST

1 absorption behavior of black toner according to the state of the art

3 absorption behavior of red toner

5 absorption behavior of paper

7 absorption behavior of water

what is claimed is:

1. Digital image recording process in which a color toner image made of toner layers having different colors is transferred onto an image receiving substrate and then fused and fixed onto the image receiving substrate by impingement with electromagnetic radiation, characterized in that, in order to produce the color black at least one toner layer is used that has similar absorption properties, at least for one wavelength within a predetermined wavelength range for the electromagnetic radiation, as the other toner layers that are used.

2. Process according to claim 1, characterized in that, the predetermined wavelength range is the range from 0.8 μm to 10 μm.

3. Process according to claim 1, characterized in that, the predetermined wavelength range is selected such that the energy of the electromagnetic radiation is predominately absorbed by the image receiving substrate and not by the toner layers.

4. Process according to claim 1, characterized in that, the predetermined wavelength range is the range from 0.8 μm to 3 μm.

5. Process according to claim 1, characterized in that, the color black is produced by a combination of different colored toner layers.

6. Process according to claim 1, characterized in that, the color black is formed or formed together with at least one toner layer that contains a combination of different colored color pigment particles.

7. Process according to claim 1, characterized in that, the color black is formed or formed together with at least one toner layer that is not pigmented with carbon black.

8. Process according to claim 1, characterized in that, the color black is formed or formed together with at least one toner layer that contains a black pigment.

9. Process according to claim 1, characterized in that, the color black is formed or formed together with at least one toner layer that has a carbon black portion of less than 2%.

10. Process according to claim 1, characterized in that, the color black is formed or formed together with at least one toner layer that contains neutral gray pigments free of carbon black.

11. Device for performing the process of claim 1.

12. Toner for a color printer and/or copier device, whereby the toner is suitable to produce the color black and provided for the purpose of being fused by electromagnetic radiation and fixed onto an image carrier substrate, characterized in that, the toner has similar absorption properties, during irradiation with electromagnetic radiation with at least one wavelength out of a predetermined wavelength range, as other toners that are provided to produce colors other than black.

13. Toner according to claim 12, characterized in that, the predetermined wavelength range is the range from 0.8 μm to 10 =m.

14. Toner according to claim 12, characterized in that, the predetermined wavelength range is the range from 0.8 μm to 3 μm.

15. Toner according to claim 13, characterized in that, when it is irradiated with electromagnetic radiation with wavelengths in the IR range below approximately 5 μm, it absorbs less than 10% of the energy.

16. Toner according to claim 13, characterized in that, the toner contains a combination of different colored particles.

17. Toner according to claim 13, characterized in that, the toner contains a combination of different colored particles that are provided to produce the colors cyan, magenta, and yellow.

18. Toner according to claim 13, characterized in that, it has no carbon black.

19. Toner according to claim 13, characterized in that, it contains a portion of carbon black of less than 2%.

20. Toner according to claim 13, characterized in that, it contains neutral gray pigments.

21. Toner according to claim 13, characterized in that, it is formed by several toner layers with different colors after it is transferred onto the image receiving substrate.

22. Toner according to claim 13, characterized in that, the toner layers with different colors contain the colors cyan, magenta, and yellow.
